(19) United States
(12) Patent Application Publication
(10) Pub. No.: US 2006/0287875 A1
(43) Pub. Date: Dec. 21, 2006

(54) Integrated customer assessment diagnostic tool

(76) Inventors: Uttam M. Reddy, Austin, TX (US); Thomas P. Capotosto, Austin, TX (US); David R. Ornelas, Austin, TX (US); Vincent J. Vargas, Austin, TX (US)

Correspondence Address: HAMILTON & TERRILE, LLP, P.O. BOX 203518, AUSTIN, TX, 78720, US

(21) Appl. No.: 11/156,987

(22) Filed: Jun. 20, 2005

(51) Int. Cl. G06Q 99/00; G05B 19/418; G06F 15/02; G06F 9/46

(52) U.S. Cl. 705/1; 705/8; 705/9

(57) ABSTRACT

A method for providing a current state assessment of a life cycle management and support structure of an information technology environment which includes defining building block services wherein a building block service is any discrete benefit explicitly provided by a vendor to a customer of the vendor and the building block service has at least one of a physical product, a service and a solution, and describing the current state of the information technology environment with the building block services as a current state assessment is disclosed.

### BACKGROUND OF THE INVENTION

1. Field of the Invention

The present invention relates to business process object modeling and more particularly to unifying business process object modeling.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the proliferation of information handling systems, especially within large scale information handling system installations, an important issue relates to the service and support of the large scale information handling system installations (i.e., installations in which more than a few information handling systems are supported by a single entity. The entity that services and supports such an installation is often referred to as a managed service provider. Managed services, or life-cycle services generally include deployment services and asset services. More specifically, managed services include some or all of asset deployment and installation services, asset management services (including, e.g., both asset tracking and asset moving services), asset maintenance services and asset retirement services.

A managed service provider provides a customer with an ability to procure, deploy, support and manage information handling system technologies across the life cycle of the information handling systems. Issues relating to managed services include information management and asset utilization while providing quality service delivery and a favorable customer experience.

Known business processes used by a managed service provider are usually defined either from scratch or are based on modifications of existing like processes. The design of business processes is usually not based upon reuse of standard elements drawn from a library or catalog of pre-defined process elements.

The underlying technology systems that are used in business processes are often vertically aligned with the overall process or solution required by the business, producing rigid, monolithic systems. This is opposed to building components that can serve as interchangeable building blocks that correspond directly to process objects that can then be mixed and matched exactly as the business process objects are mixed and matched.

Continually creating new processes from scratch, as opposed to reusing standard pre-defined process elements or building blocks, results in a proliferation of similar but different processes that are sometimes conflicting, sometimes duplicative, resulting in process inefficiencies, inability to achieve process integration, inability to achieve consolidated reporting and management, inability to reuse intellectual capital, and creation of technology requirements that are both conflicting and duplicative. This in turn compromises the ability to create reusable technology building blocks, thereby cascading the same set of problems into the technology infrastructure (i.e., inefficiencies; integration; consolidation, reuse of technology, intellectual capital, and scarce resources; quality, scalability; extensibility; and manageability and supportability).

For example, referring to FIG. 1, labeled prior art, lifecycle components of a managed service process establish a baseline of existing assets at step 110. Lifecycle services add new assets, acquire new assets, order a product and install new assets or order a service at step 112. Lifecycle components request lifecycle changes to existing assets by moving or upgrading existing assets, order a service and maintaining existing assets, or report a problem at step 114. Lifecycle service components retire and replace existing assets by disposing of old assets, order a service and install new assets, or order a service at step 116.

One issue of lifecycle components relates to the process of creating a current state assessment of the life cycle management and support structure of a customer's information technology environment and using the assessment to drive a resulting desired state solution. Due to this issue, a low degree of repeatability of the end-to-end methodology often produces varyingly effective results. A high degree of expertise is often needed to perform the assessment and ensuring that the solution operates properly often results in the need to employ skilled resources. The issue often results in a lack of tight linkages between the assessment and the ensuing solution design and between the solution design and the final implementation, thus resulting in resource and time inefficiencies in the solution process. The issue often yields solutions that do not conform to the customer business objectives and requirements. The lack of the use of standardized building blocks often results in a low degree of standardized, reusable solutions. This in turn results in solutions that are more expensive to support and maintain over time.

### SUMMARY OF THE INVENTION

In accordance with the present invention, an application of a unifying process object modeling is disclosed. The application provides for direct input into and creation of downstream artifacts in the lifecycle services solution development process based on an up front customer current state assessment. The assessment yields detailed information in the form of building block process elements, operational costs, and state data such as number of assets to be managed and volumes and types of service events.

The application results in a documented current state assessment of a customer's environment in a manner that facilitates automated generation of clearly traceable downstream artifacts such as a return on investment (ROI) analysis, a solution blueprint, a transition plan, solution design specifications and a solution implementation.

The application minimizes the need for interpretation of otherwise ambiguous information, thus producing substantially optimal designs based on precise information flow and heuristics. The application enables a highly reusable methodology for assessing customer environments and using the assessment to ultimately produce an optimized customer solution.

These factors result in efficient use of time by technical resources and results in an overall cost reduction and reduction in time from assessment to final solution. The application and also results in the creation of predictable downstream results that enables more effective early planning and cost estimation. The ability to fulfill the customer business objectives and requirements is increased by using the application and accordingly customer satisfaction is increased.

The application produces highly leveragable, standardized work product, in terms of knowledge base about customer environments, solution and design artifacts, business process objects, and solution technology and processes.

Through the use of standardized process and information building blocks at each step of the process, the application provides a documented current state assessment of a customer's environment in a manner that facilitates automated generation of clearly traceable downstream artifacts such as ROI analysis, solution blueprint, transition plan, solution design specifications and solution implementation.

The application decomposes the current customer environment into its underlying business process objects, including the objects' respective states and uses the same business process objects to define the desired state condition, compliant with the customer business objectives and requirements. This process is referred to as the solution blueprint.

The ROI analysis is based on the state data of the current business process objects to derive the baseline costs, while the investment is derived from the cost to implement the desired state business process objects which are defined within the solution blueprint.

The transition plan is derived from analyzing the tasks needed to progress from the current state to the desired state.

The solution design specifications are derived directly from the solution blueprint, and are based on the lowest, irreducible level of process objects, information objects, and their attributes.

The solution implementation applies the solution design specifications against the processes, resources, and technology within the customer environment and the supporting managed service provider environment.

In one embodiment, the invention relates to a method for providing a current state assessment of a life cycle management and support structure of an information technology environment which includes defining building block services wherein a building block service is any discrete benefit explicitly provided by a vendor to a customer of the vendor and the building block service has at least one of a physical product, a service and a solution, and describing the current state of the information technology environment with the building block services as a current state assessment.

In another embodiment, the invention relates to an apparatus for providing a current state assessment of a life cycle management and support structure of an information technology environment which includes means for defining building block services wherein a building block service is any discrete benefit explicitly provided by a vendor to a customer of the vendor and the building block service including at least one of a physical product, a service and a solution, and means for describing a current state of the information technology environment with the building block services as a current state assessment.

In another embodiment, the invention relates to a system for providing a current state assessment of a life cycle management and support structure of an information technology environment which includes a plurality of building block services, each of the plurality of building block services is a discrete benefit explicitly provided by a vendor to a customer of the vendor, each of the plurality of building block services including at least one of a physical product, a service and a solution, and a current state module wherein the current state module describing a current state assessment of the information technology environment with the building block services.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled prior art, shows a block diagram of a lifecycle for establishing a baseline for existing assets.

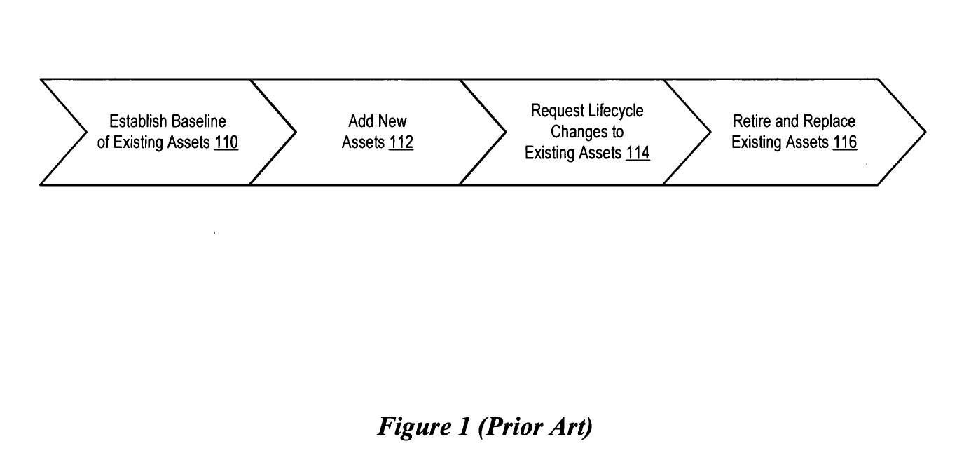

FIG. 2 shows a block diagram of an integrated customer assessment diagnostic tool.

FIG. 3 shows a block diagram of an asset assessment tool.

FIG. 4 shows a block diagram of a service building block repository tool.

FIG. 5 shows a block diagram of the output of the integrated customer assessment diagnostic tool.

### DETAILED DESCRIPTION

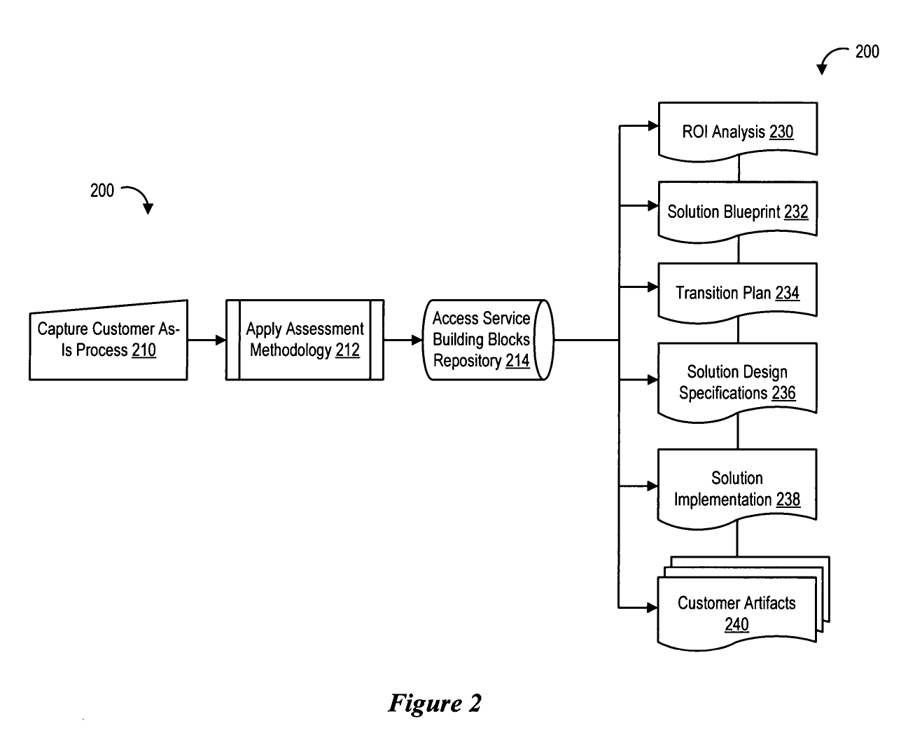

Referring to FIG. 2, a block diagram of an integrated customer assessment diagnostic tool 200 is shown. The integrated customer assessment diagnostic tool 200 provides an application of a unifying process object modeling. The integrated customer assessment diagnostic tool 200 provides for direct input into and creation of downstream artifacts in the lifecycle services solution development process based on an up front customer current state assessment. The assessment yields detailed information in the form of building block process elements, operational costs, and state data such as number of assets to be managed and volumes and types of service events.

More specifically, the integrated customer assessment diagnostic tool 200 captures a customer as-is process at step 210. The capture provides a solution modeling approach that is based on standardized reusable process objects and information objects (with attributes such as cost service incident levels, constraints, etc). The integrated customer assessment diagnostic tool 200 then executes an assessment tool 212 which applies an assessment methodology provide a customer current state assessment. The integrated customer assessment diagnostic tool 200 then accesses a service building blocks repository tool 214 which allows for easy manipulation of the assessment into a desired state solution.

The integrated customer assessment diagnostic tool 200 results in a documented current state assessment of a customer's environment in a manner that facilitates automated generation of clearly traceable downstream artifacts 220. The downstream artifacts 220 include a return on investment (ROI) analysis 230, a solution blueprint 232, a transition plan 234, solution design specifications 236 and a solution implementation 238 as well as other customer artifacts 240.

The integrated customer assessment diagnostic tool 200 minimizes the need for interpretation of otherwise ambiguous information, thus producing substantially optimal designs based on precise information flow and heuristics. The integrated customer assessment diagnostic tool 200 enables a highly reusable methodology for assessing customer environments and using the assessment to ultimately produce an optimized customer solution.

These factors result in efficient use of time by technical resources and results in an overall cost reduction and reduction in time from assessment to final solution. The integrated customer assessment diagnostic tool 200 also results in the creation of predictable downstream results that enables more effective early planning and cost estimation. The ability to fulfill the customer business objectives and requirements is increased by using the application and accordingly customer satisfaction is increased.

The integrated customer assessment diagnostic tool 200 produces highly leveragable, standardized work product, in terms of knowledge base about customer environments, solution and design artifacts, business process objects, and solution technology and processes.

Through the use of standardized process and information building blocks at each step of the process, the integrated customer assessment diagnostic tool 200 provides a documented current state assessment of a customer's environment in a manner that facilitates automated generation of clearly traceable downstream artifacts such as ROI analysis, solution blueprint, transition plan, solution design specifications and solution implementation.

The integrated customer assessment diagnostic tool 200 decomposes the current customer environment into its underlying business process objects, including the objects' respective states and uses the same business process objects to define the desired state condition, compliant with the customer business objectives and requirements. This process is referred to as the solution blueprint 232. The ROI analysis 230 is based on the state data of the current business process objects to derive the baseline costs, while the investment is derived from the cost to implement the desired state business process objects which are defined within the solution blueprint. The transition plan 234 is derived from analyzing the tasks needed to progress from the current state to the desired state. The solution design specifications 236 are derived directly from the solution blueprint, and are based on the lowest, irreducible level of process objects, information objects, and their attributes. The solution implementation 238 applies the solution design specifications against the processes, resources, and technology within the customer environment and the supporting managed service provider environment.

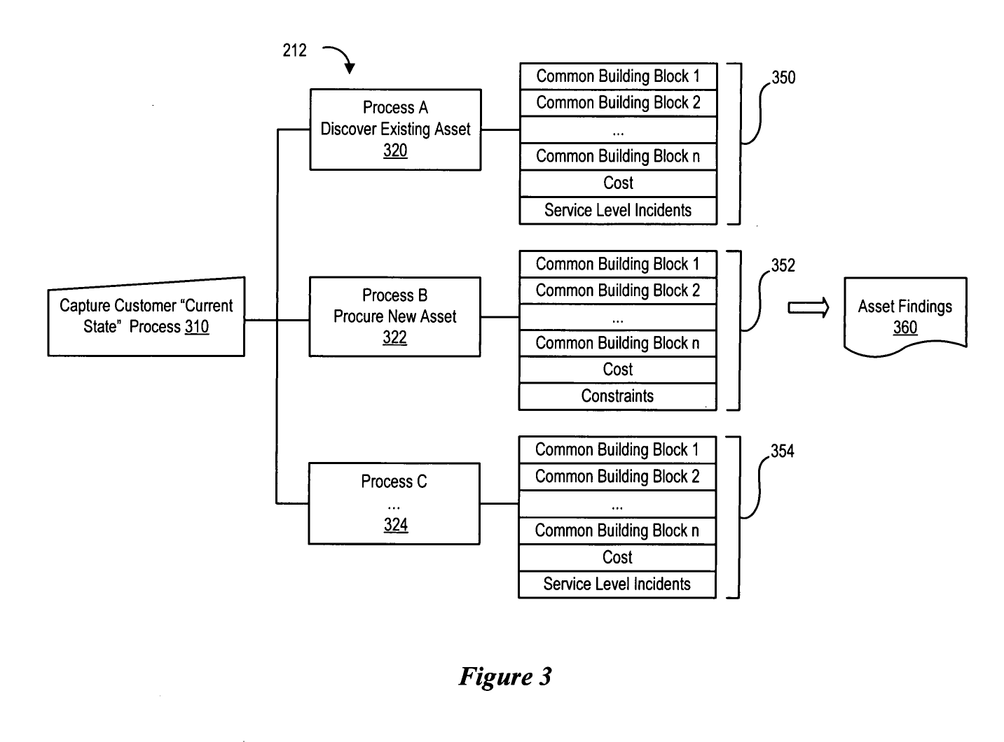

Referring to FIG. 3, a block diagram of an asset assessment tool 212 is shown. More specifically, the asset assessment tool 212 receives the captured customer current state process at step 310. The asset assessment tool 212 than performs a plurality of processes (Process A 320, Process B 322, Process C 324) on the current state process. For example, the assessment tool 212 may perform a discover existing asset process (e.g., process A 320). The assessment tool may also perform a procure new asset process (e.g., process B 322).

Each of the processes include a plurality of common building blocks 350, 352, 354. The result of the performance of the plurality of processes is a set of assessment findings 360. The assessment findings 360 are an artifact built from the assessment methodology which establishes current mode of operations and opportunities for improvement.

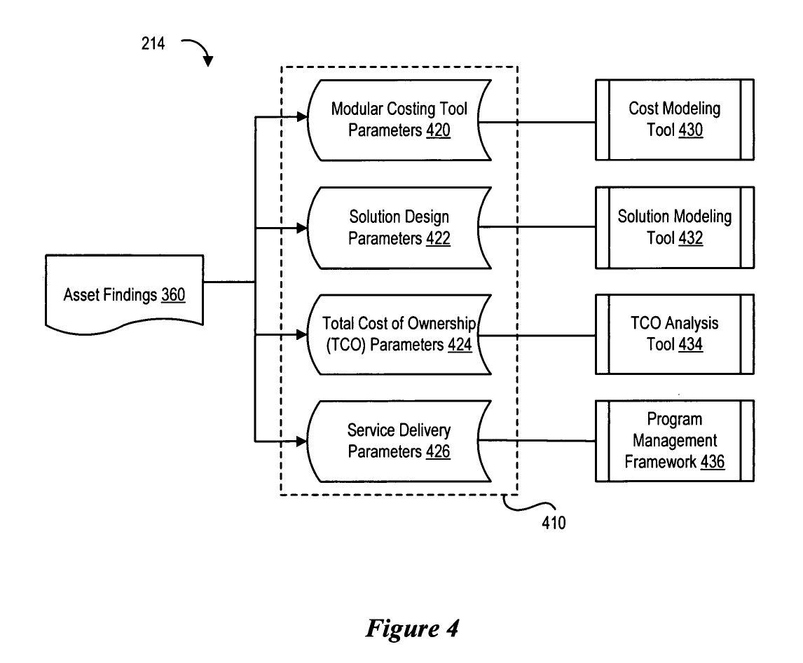

Referring to FIG. 4, a block diagram of a service building block repository tool 214 is shown. The service building block repository tool 214 receives the assessment findings at step 360 and uses the parameters 410 within the assessment findings to access against service building blocks and common data that is fed to the appropriate tool within the service building block repository tool 214.

The parameters 410 can include modular costing tool parameters 420, solution design parameters 422, total cost of ownership (TCO) parameters 424 and service delivery parameters 426. The modular costing tool parameters 420 are provided to a cost modeling tool 430. The solution design parameters 422 are provided to a solution modeling tool 432. The total cost of ownership (TCO) parameters 424 are provided to a TCO analysis tool 434. The service delivery parameters 426 are provided to a program management framework tool 436.

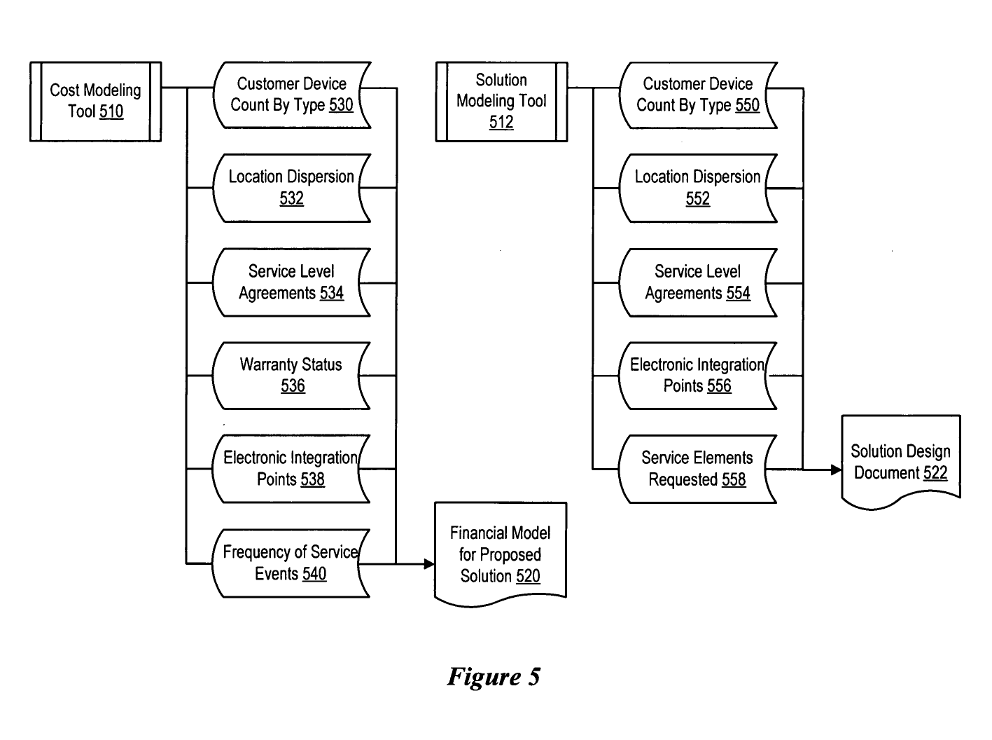

Referring to FIG. 5, a block diagram of the output of the integrated customer assessment diagnostic tool 200 is shown. More specifically, output from the integrated customer assessment diagnostic tool 200 is provided to a cost modeling tool 510 and to a solution modeling tool 512. The cost modeling tool 510 provides a financial model for a proposed solution 520. The solution modeling tool 512 provides a solution design documents 522. The financial model for a proposed solution 520 and the solution design documents 522 provide a unified output based upon a single data feed.

The cost modeling tool 510 includes a plurality of cost modeling modules. More specifically, the cost modeling tool 510 includes a customer device count by type module 530, a location dispersion tool 532, a service level agreements module 534, a warranty status module 536, an electronic integration points module 538 and a frequency of service events module 540.

The solution modeling tool 512 includes a plurality of solution modeling modules. More specifically, the solution modeling tool 512 includes a customer device count by type module 550, a location dispersion module 552, a service level agreements module 554, an electronic integration points module 556 and a service elements requested module 558.

Similar modules within the cost modeling tool 510 and the solution modeling tool 512 use common data objects from the assessment methodology. So for example, the location dispersion module 532 and the location dispersion module 552 use common data objects from the assessment methodology.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for providing a current state assessment of a life cycle management and support structure of an information technology environment comprising:
defining building block services, a building block service being any discrete benefit explicitly provided by a vendor to a customer of the vendor, the building block service including at least one of a physical product, a service and a solution; and,
describing the current state of the information technology environment with the building block services as a current state assessment.

2. The method of claim 1 wherein:
the current state assessment is directly and automatically linked to generation of a desired state solution blueprint; and,
the physical product includes an information handling system, the service includes installation or repair of the physical product, and the solution includes a combination of properly configured information technology systems, clearly defined business processes, and trained personnel.

3. The method of claim 2 wherein:
the current state assessment and the desired state solution blueprint are directly and automatically linked to creation of a return on investment analysis of the proposed solution.

4. The method of claim 2 wherein:
the current state assessment and the desired state solution blueprint are directly and automatically linked to creation of a transition plan that guides transformation from current state to desired state.

5. The method of claim 2 wherein:
the desired state solution blueprint is directly and automatically linked to creation of solution design specifications.

6. The method of claim 5 wherein:
the solution design specifications are directly and automatically linked to the creation of a solution implementation.

7. The method of claim 1 wherein:
the building block services can be defined according to a standard construct of irreducible objects or primitives.

8. An apparatus for providing a current state assessment of a life cycle management and support structure of an information technology environment comprising:
means for defining building block services, a building block service being any discrete benefit explicitly provided by a vendor to a customer of the vendor, the building block service including at least one of a physical product, a service and a solution; and,
means for describing a current state of the information technology environment with the building block services as a current state assessment.

9. The apparatus of claim 8 wherein:
the current state assessment is directly and automatically linked to generation of a desired state solution blueprint; and,
the physical product includes an information handling system, the service includes installation or repair of the physical product, and the solution includes a combination of properly configured information technology systems, clearly defined business processes, and trained personnel.

10. The apparatus of claim 9 wherein:
the current state assessment and the desired state solution blueprint are directly and automatically linked to creation of a return on investment analysis of the proposed solution.

11. The apparatus of claim 9 wherein:
the current state assessment and the desired state solution blueprint are directly and automatically linked to creation of a transition plan that guides transformation from current state to desired state.

12. The apparatus of claim 9 wherein:
the desired state solution blueprint is directly and automatically linked to creation of solution design specifications.

13. The apparatus of claim 12 wherein:
the solution design specifications are directly and automatically linked to the creation of a solution implementation.

14. The apparatus of claim 8 wherein:
the building block services can be defined according to a standard construct of irreducible objects or primitives.

15. A system for providing a current state assessment of a life cycle management and support structure of an information technology environment comprising:
a plurality of building block services, each of the plurality of building block services being a discrete benefit explicitly provided by a vendor to a customer of the vendor, each of the plurality of building block services including at least one of a physical product, a service and a solution; and,
a current state module, the current state module describing a current state assessment of the information technology environment with the building block services.

16. The system of claim 15 wherein:
the current state assessment is directly and automatically linked to generation of a desired state solution blueprint; and,
the physical product includes an information handling system, the service includes installation or repair of the physical product, and the solution includes a combination of properly configured information technology systems, clearly defined business processes, and trained personnel.

17. The system of claim 16 wherein:
the current state assessment and the desired state solution blueprint are directly and automatically linked to creation of a return on investment analysis of the proposed solution.

18. The system of claim 16 wherein:
the current state assessment and the desired state solution blueprint are directly and automatically linked to creation of a transition plan that guides transformation from current state to desired state.

19. The system of claim 16 wherein:
the desired state solution blueprint is directly and automatically linked to creation of solution design specifications.

20. The system of claim 19 wherein:
the solution design specifications are directly and automatically linked to the creation of a solution implementation.

21. The system of claim 15 wherein:
the building block services can be defined according to a standard construct of irreducible objects or primitives.
